(19) United States
(12) Patent Application Publication
(10) Pub. No.: US 2012/0163508 A1
(43) Pub. Date: Jun. 28, 2012

(54) SUBCARRIER PLACEMENT STRATEGY FOR A MULTI-CARRIER SIGNAL

(75) Inventors: STEPHEN L. KUFFNER, ALGONQUIN, IL (US); LAWRENCE M. ECKLUND, WHEATON, IL (US)

(73) Assignee: MOTOROLA, INC., Schaumburg, IL (US)

(21) Appl. No.: 12/979,133

(22) Filed: Dec. 27, 2010

(51) Int. Cl. H04L 27/04; H04L 27/06

(52) U.S. Cl. 375/340; 375/295

(57) ABSTRACT

Communication devices and methods for transmitting and receiving a wideband signal using aggregated discontiguous narrowband channels in a band are presented. During transmission, a fold point is determined in which symmetric free channels are sufficient to transmit the signal. The signal is then synthesized by aggregating the data in the channels and transmitted using the fold point as the up-conversion modulation frequency. During reception, information regarding which channels are being used to provide data signals and which channels are occupied by interferers is received. This information is used to determine one or more fold points as the down-conversion modulation frequencies. The fold points are selected such that an image of each interferer falls on an unoccupied channel or a narrowband channel occupied by another interferer.

### TECHNICAL FIELD

The present disclosure relates generally to communication systems and in particular to a method of subcarrier placement within a band.

### BACKGROUND

In wireless communications, different frequency bands are set aside by the Federal Communications Commission (FCC) or other regulatory agencies for different purposes. Users of a particular frequency band may be primary or secondary, licensed or unlicensed users. In principle, it is possible to opportunistically reuse spectrum via cognitive radio techniques such that when a portion of the spectrum is vacant (e.g., licensed users are not currently using the specific channels assigned to them), it can be occupied by another set of users, dependent on policy considerations. In general, in an opportunistic spectrum reuse environment, the spectrum availability is dictated by the licensed channels and their usage patterns in a given area. The specific technical details of the licenses granted by the regulatory agency include frequency, Equivalent Isotropically Radiated Power (EIRP) and tower height (e.g., of base stations serving communication devices) that can generally be obtained from a database which allows calculations of the protected operating zones (or ‘contours’) for the licensee.

For narrowband spectrum such as land mobile, considerations for spectrum assignments for a given base station are generally influenced by practical factors such as high-power cavity combiner frequency spacing. These combiners consist of a multiplicity of extremely high Q resonant cavities that are coupled to a common port which ultimately feeds the base station transmit antenna. The cavities are spaced far enough apart in frequency so that they do not significantly load each other and divert power from reaching the antenna. Thus, a given licensee's spectrum is generally narrow channels distributed over a wide bandwidth. Local combinations of such licensees in mobile radio spectrum lead to highly fractured spectrum occupancy at any given time and place, and a correspondingly fractured spectrum opportunity.

The fracturing of the available spectrum into disparate channels becomes more prevalent when the desired transmission bandwidth is increased. In one example, the data rate of conventional narrowband land mobile spectrum is relatively low (<10 kbps) due to the narrow allocations of 12.5 kHz. To provide higher data rate services, it becomes necessary to aggregate multiple available channels. Such higher data rate services are most in demand in highly populated areas that, unfortunately, also have the most highly fractured spectrum due to usage. Thus, the spectral opportunities (channels) that are to be aggregated to synthesize a sufficient amount of bandwidth are more likely to be non-contiguous and asymmetrical (i.e., for a given set of channels and occupants, it is not possible to find a frequency about which the spectral opportunities are symmetrically located). Similarly, in a spectrum containing a noncontiguous multi-channel signal, interferers are likely to be asymmetrically distributed across the spectrum.

Thus, a portable communication device (hereinafter also referred to as a ‘radio’) operating in such an environment will be expected to cope with the distributed, asymmetric nature of the spectrum in both receive and transmit functions. Among the greatest challenges in both of these aspects is the finite balance performance of a radio's quadrature channel separation, which impacts the susceptibility of the receiver of the radio to interference and unintended emissions of the transmitter of the radio, which can cause interference to other users. The quadrature channel separation is impaired by two practical limitations in both receive and transmit applications—the gain and phase balance of the IQ modulator and demodulator. As is well known by those skilled in the art, even small amounts of imbalance result in imperfect cancellation of images.

For the portable radio receiver operating in such distributed spectrum, a direct conversion IQ demodulator relies on gain and phase balance to minimize the residue of asymmetrically disposed large interferers from appearing as an attenuated but still harmful image reflected to the other side of the conversion center frequency. For the radio transmitter, a direct launch IQ modulator relies on gain and phase balance to suppress the generation of harmful images of the distributed channel opportunity from impairing the sensitivity of other users on their channels. These same impairments limit the performance of single sideband modulators and image reject mixers, which are well known to those skilled in the art. Thus, the limitations of typical radio signal processing hinders practical usage of highly fractured spectrum.

Returning to the receiver, competitive high performance land mobile radios are expected to operate in the presence of blocker signals that may be 80-100 dB larger than the desired signal. In the distributed, asymmetric spectrum that is available for aggregation into wideband channels, rejection of the images of such blockers becomes necessary if they fall on desired channels. Typical image rejection of direct conversion receivers is on the order of 40 dB, which can generally be improved to perhaps 50-60 dB using various calibration techniques. This level of performance is more than adequate for a radio that is operating on a single channel. However, for a radio that is wideband and coping with multiple channels across the bandwidth, such rejection can still leave images >20 dB stronger than a signal to be communicated and that are still harmful, especially if they fall on a weak desired channel.

While coping with image rejection-limited large blocker interference in the receiver is a problem, it is problem only to the radio's user, who can make a market choice to either use or not use a poorly performing radio. In the transmitter, the limited image rejection becomes a problem for other users of the spectrum and hence falls under the domain of regulatory agencies. In land mobile radio spectrum, multi-carrier opportunistic reuse transmitters are expected to perform at emission levels (mask levels) comparable to existing spectral occupants, e.g., at least 67 dBc/6 kHz as for National Telecommunications and Information Administration (NTIA) non-700 MHz spectrum. Satisfying this mask level presents several formidable challenges for a distributed multi-carrier transmitter. To achieve spectral mask targets, a minimum modulator gain/phase balance of at least 7.8 mdB and 51 m° (i.e., 0.0078 dB, 0.051°) is required, and this does not allow any margin for contributions from other transmitter impairments such as intermodulation and phase noise. This is an extremely high degree of balance that is not typically feasible in a production environment. Moreover, even if careful calibration could be achieved, such performance is not able to be sustained due to drift that normally occurs due to environmental and aging conditions in the circuitry of the communication device. Further, this balance must be maintained not just at a single frequency, but across the entire modulation bandwidth. This is complicated by the fact that the balance is not limited to that of the mixer-summer portion of the modulator, but also to the gain and phase balance of the baseband reconstruction filters as well as the IQ digital-to-analog converter's (DAC's) range and timing balance. For low cost direct-launch transmitter architectures, there is a need for a carrier placement strategy that obviates the need for such extreme modulator balance.

There have thus been prior art attempts to calibrate the IQ modulator in a system to achieve such a precise degree of balance. However, previous attempts at such exacting modulator calibration (in which a demodulator has a balance that is as good as, or better than, the desired modulator balance) have not yielded, and are unlikely in the future to yield, the degree of balance for the demanding environments encountered in land mobile radio. It is thus desirable to provide a low cost radio solution that avoids the above problems and allows channels to be aggregated into a desired amount of bandwidth.

### BRIEF DESCRIPTION OF THE FIGURES

The accompanying figures, where like reference numerals refer to identical or functionally similar elements throughout the separate views, together with the detailed description below, are incorporated in and form part of the specification and serve to further illustrate various embodiments of concepts that include the claimed invention, and to explain various principles and advantages of those embodiments.

FIG. 1 illustrates one embodiment of a communication system.

FIG. 2 illustrates one embodiment of a radio used in the communication system of FIG. 1.

FIG. 3 illustrates one embodiment of a block diagram of aspects of the radio of FIG. 2.

FIGS. 4A and 4B show a spectrum with a single interferer.

FIGS. 5A and 5B show a spectrum with multiple interferers.

FIG. 6 shows another spectrum with multiple interferers.

FIG. 7 illustrates a flowchart of a method of reception using fold point(s) and available channels.

FIG. 8 shows a spectrum with available and occupied channels.

FIG. 9 shows the number of symmetrically placed channels versus fold point for the distribution of FIG. 8.

FIGS. 10A and 10B respectively illustrate the spectrum of FIG. 8 with outlining and an enhanced view of FIG. 10A containing the maximum number of symmetric channels.

FIGS. 11A and 11B illustrate a flowchart of a method of determining desirable fold point(s) and available channels for transmission.

FIG. 12 shows an embodiment of a radio.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Communication devices, systems, and methods for transmitting and receiving a wideband signal using aggregated discontiguous narrowband channels in a band are presented. During transmission, a frequency ‘fold point’ or center frequency is determined about which symmetric channels are found to be available and in sufficient quantity to transmit the signal. The symmetric channels are used so that imperfectly suppressed transmitter images fall only on other modulated channels from the same radio if possible. The signal is then synthesized by distributing the data over parallel channels which are then modulated onto the aggregated physical channels and transmitted using the fold point as the up-conversion center frequency (i.e., the carrier frequency used for transmission). During reception, information regarding which channels are being used to provide the data signal is provided by a system control channel and which channels are occupied by interferers is observed via spectral analysis in the wideband receiver. This information is used to determine one or more receive fold points as the down-conversion center frequencies. The receiver fold points are selected such that an image of each interferer falls on an unoccupied channel or a narrowband channel occupied by another interferer.

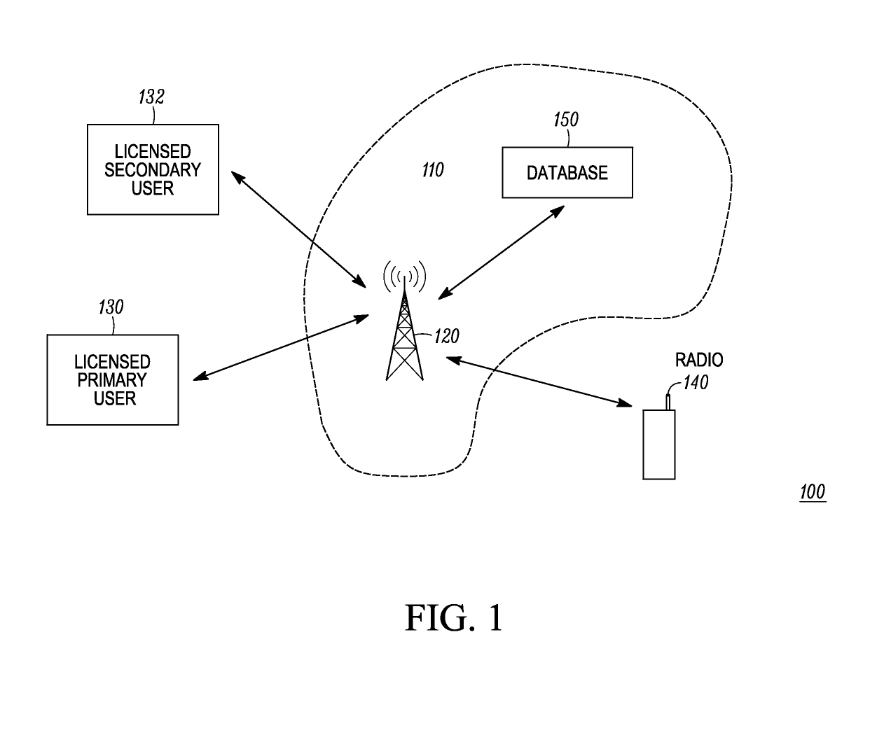

FIG. 1 illustrates a communication system 100 such as a cognitive radio communication system. The communication system 100 includes radios 140 that communicate to other elements through base stations 120 in an infrastructure 110 in an indirect operation mode. In a direct mode operation mode the radios 140 communicate directly, without use of the infrastructure 110. In addition, licensed primary and secondary users 130, 132 of the spectrum, as well as databases 150 are shown in the communication system.

Only base station 120, licensed primary and secondary users 130, 132, and radio 140 is shown in the communication system 100 for convenience. Unlicensed secondary users are not shown, although they too may be present depending on regulatory policy. The radio 140 can be, for example, a mobile (personal or vehicular) communication device such as a Cognitive Radio (CR), a cellular telephone, push-to-talk (PTT) land mobile radio communication device, personal digital assistant (PDA), laptop computer or any other such device in wired or wireless communication. The infrastructure 110 contains distributed elements, some local to each other and others disposed geographically distant from each other. Such elements may include a server as well as bridges, switches, zone controllers, base station controllers, repeaters, base radios, access points, routers, databases or any other type of infrastructure equipment facilitating communications between entities in a wireless or wired environment and many other elements known in the art but not shown or described herein for brevity.

As indicated previously, licensed transmitter parameter databases that contain information about the transmission characteristics of each incumbent system and device licensed to transmit in the spectrum are often maintained by regulatory agencies such as the FCC. One example of such a transmitter parameter database is the FCC's Consolidated Data Base System (CDBS). These databases are accessible to secondary devices that are intended to communicate in the spectrum.

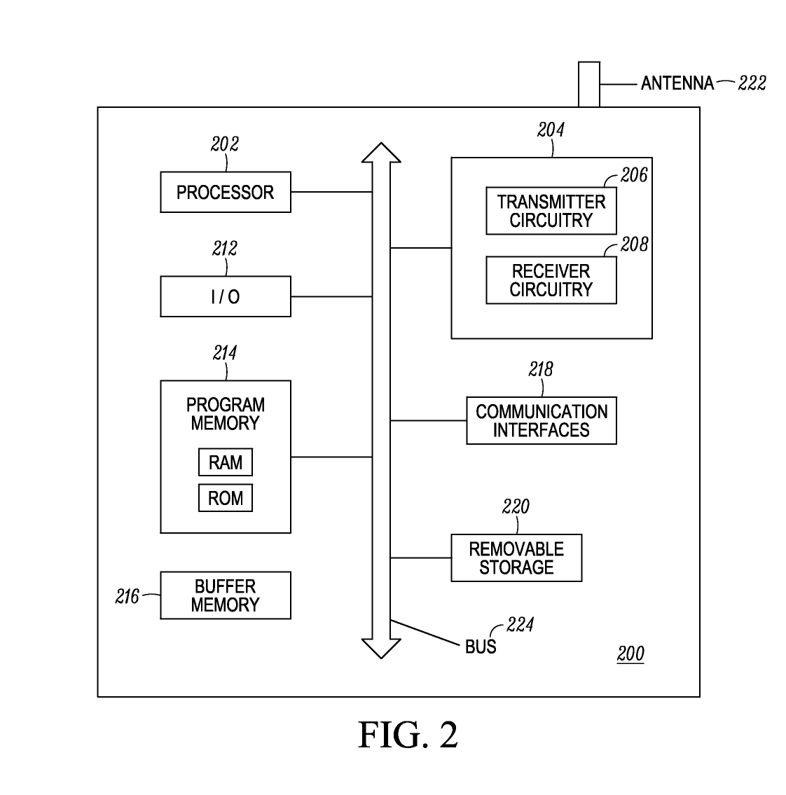

An embodiment of a radio is shown in the block diagram of FIG. 2. The radio 200 may contain, among other components, a processor 202, a transceiver 204 including transmitter circuitry 206 and receiver circuitry 208, an antenna 222, I/O devices 212, a program memory 214, a buffer memory 216, one or more communication interfaces 218, and removable storage 220. The transmitter circuitry 206 and receiver circuitry 208 allow the communication device to act as a transmitter (transmitting information) or a receiver (receiving information), as desired. The radio 200 is preferably an integrated unit and may contain the elements depicted in FIG. 2 as well as any other element necessary for the radio 200 to perform its electronic functions. The electronic elements are connected by a bus 224.

The processor 202 includes one or more microprocessors, microcontrollers, DSPs, state machines, logic circuitry, or any other device or devices that process information based on operational or programming instructions. Such operational or programming instructions are stored in the program memory 214 and may include instructions such as estimation and correction of a received signal and encryption/decryption that are executed by the processor 202 as well as information related to the transmit signal such as modulation, transmission frequency or signal amplitude. The program memory 214 may be an IC memory chip containing any form of random access memory (RAM) and/or read only memory (ROM), a floppy disk, a compact disk (CD) ROM, a hard disk drive, a digital video disk (DVD), a flash memory card or any other medium for storing digital information. One of ordinary skill in the art will recognize that when the processor 202 has one or more of its functions performed by a state machine or logic circuitry, the memory 214 containing the corresponding operational instructions may be embedded within the state machine or logic circuitry. The operations performed by the processor 202 and the rest of the radio 200 are described in detail below.

The transmitter circuitry 206 and the receiver circuitry 208 enable the radio 200 to respectively transmit and receive communication signals using a desired narrowband modulation such as analog FM or C4FM (a pulse-shaped 4-level FSK modulation used by land mobile) or wideband modulation techniques such as Orthogonal Frequency-Division Multiplexing (OFDM, a digital aggregation of many contiguous narrowband tones) or Filtered Multi-Tone (FMT, a digital aggregation of many contiguous pulse-shaped narrowband carriers). In this regard, the transmitter circuitry 206 and the receiver circuitry 208 include appropriate circuitry to enable wireless transmissions. The implementations of the transmitter circuitry 206 and the receiver circuitry 208 depend on the implementation of the radio 200 and the devices with which it is to communicate. For example, the transmitter and receiver circuitry 206, 208 may be implemented as part of the communication device hardware and software architecture in accordance with known techniques. One of ordinary skill in the art will recognize that most, if not all, of the functions of the transmitter or receiver circuitry 206, 208 may be implemented in a processor, such as the processor 202. However, the processor 202, the transmitter circuitry 206, and the receiver circuitry 208 have been artificially partitioned herein to facilitate a better understanding. The buffer memory 216 may be any form of volatile memory, such as RAM, and is used for temporarily storing received or transmit information.

The radio 200 may also contain a variety of I/O devices such as a keyboard with alpha-numeric keys, a display (e.g., LED, OLED) that displays information about the communication device or communications connected to the communication device, soft and/or hard keys, touch screen, jog wheel, a microphone, and a speaker.

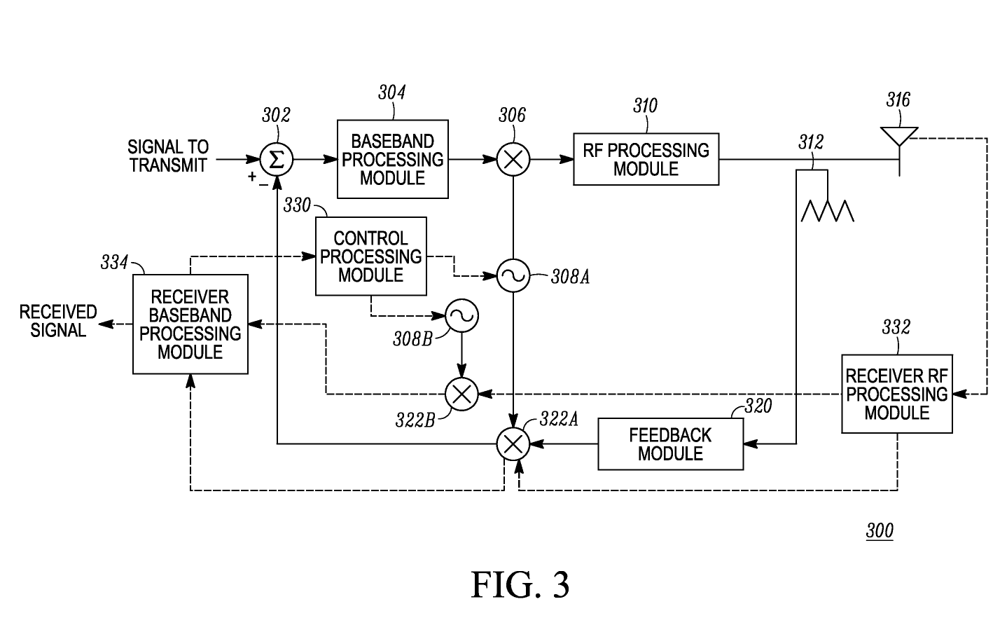

A basic block diagram of one embodiment of a typical radio is shown in FIG. 3. Although the radio 300 may use both in-phase (I) and quadrature-phase (Q) signals, only one complex signal path is shown for convenience. An analog baseband signal to be transmitted is provided to a summer 302. The signal processes such as conversion from a digital format to analog format, filtering and amplification may be present but have not been shown. The resulting signal from the summer 302 is provided to a baseband processing module 304, converted to an RF signal using an up-conversion mixer (also called up-converter or modulator) 306 and further processed using the RF processing module 310 before being transmitted by antenna 316. The baseband processing module 304 and RF processing module 310 may include filters, adjustable or fixed amplifiers, DC offset or other error correction modules due to e.g. IQ modulator imbalance, as well as state machines and processors to control the various internal modules. The up-conversion mixer 306 is supplied with an LO signal from a local oscillator (LO) 308A.

A coupler 312 detects the signal to be transmitted by the antenna 316 and supplies this signal to a feedback processing module 320. The feedback may be simply for the purpose of monitoring or leveling the transmit power, or it may be more sophisticated processing such as linearization to reduce unintended spectral emissions due to intermodulation. The feedback processing module 320 may include filters and adjustable or fixed amplifiers. Although the feedback processing module 320 is shown as operating on the signal at RF frequency, in addition or alternatively they may operate on the signal at baseband frequency. The processed signal from the feedback processing module 320 is provided to a down-conversion mixer 322A (also called down-converter or demodulator), which is also supplied with the LO signal from the LO 308A. The resulting baseband signal is then fed back to the summer 302.

As shown, the control processing module 330 is supplied information (shown by a dashed line) received from a receiver baseband processing module 334. The control processing module 330 may contain elements similar to the above and adjust the frequency of the LO 308A and perhaps a second LO 308B to provide LO signals of independent and different frequencies in a manner to be explained below. Control information for unchanging radio elements may originate from read-only memory stored in the radio. Using the adapting control information, the LOs 308A and 308B are adjusted so that a signal (shown by a dot-dashed line) containing data in the narrowband channels is received by the antenna 316 and processed by a RF receiver processing module 332 containing elements (e.g., amplifiers, filters) similar to those in the RF processing module 310 in principle is down-converted by the LOs 308A and 308B. The down-converted signal is subsequently provided to the baseband receiver processing module 334, which again contains elements similar to RF processing modules 310 and/or RF receiver processing module 332, and results in the desired wideband signal being extracted from data in the narrowband channels.

In one particular embodiment that is well suited for the reuse of vacant land mobile radio spectrum composed of 12.5 kHz channels in the 700/800 MHz spectrum or the UHF 450-512 MHz spectrum, the radio is a cognitive radio that aggregates multiple discontiguous narrowband (12.5 kHz) channels within the desired spectrum (or band) to synthesize a wideband channel and provide wideband data service. As it is unlikely that occupation by narrowband channels within a particular band will be uniform for reasons described above, a method has been developed to provide aggregation of the available opportunities in the asymmetrically-occupied spectrum that avoids the need for extreme IQ modulator balance by paying careful consideration to the placement of imperfectly suppressed receiver or transmitter images. For the transmitter, aggregation of the narrowband channels is provided by searching for either the maximum symmetric opportunity in the asymmetrically occupied spectrum, or searching for symmetric opportunities, the number of which are at least above a predetermined bandwidth threshold selected to provide the sufficient bandwidth to provide desired wideband service. By finding symmetric opportunities disposed about a center frequency, in one embodiment by selection of the center frequency for the direct launch modulator, the use of control loops for extreme (and likely unattainable) modulator balance can be avoided, as can generation of the signal from the digital to analog converter at an IF frequency and use of the additional size and cost of a multiple-conversion transmitter lineup, an unwelcome burden for competitive modern portable land mobile radios that are expected to operate over multiple RF bands. In other embodiments, the use of control loops and/or use of an IF frequency can be used in addition to finding the symmetric opportunities.

As previously introduced, the channels occupied by licensed users are typically asymmetrically distributed across the spectrum in which the opportunistic reuse radio is intended to operate. After setting a particular frequency fold point in the band, the amount of symmetric (about the fold point) opportunistic spectrum available using the fold point as the LO frequency of the LO can be evaluated. Thus, the fold point as used herein is defined as an LO frequency of the local oscillator in a wireless communication device used to communicate (transmit or receive signals) with another wireless communication device such as a base station. Some fold points, by having occupied licensed channels around them falling on top of each other once folded, will yield more symmetric spectrum than others, and a particular fold point may yield a maximum number of available channels. By choosing this fold point as the direct launch LO frequency, a symmetric baseband IQ spectrum can be generated. Note that this baseband IQ spectrum is symmetric in terms of selected channels but not information content, as the data in each channel is different to form the aggregated wideband channel.

The degree of gain and phase balance for image rejection to satisfy the requirements of operation in demanding land mobile spectrum is impractical for even a single frequency, let alone over a bandwidth of many frequencies. With the use of spectrum that is symmetrically disposed about a fold point, modulator balance limitations that would result in the generation of objectionable images still generate symmetrically disposed images, however they now fall on other carriers—carriers that are already being exploited for the opportunistic reuse, and so would be exempt from the policy-driven spectral mask requirements since they are basically a self-interference. The degree of modulator balance or image suppression needed is then only that which supports the highest order modulation and coding rate in the opportunistic air interface in the presence of independent fading of the opportunistic carriers. Here the typical balance performance of 40 dB is more than sufficient even for the highest order modulations, e.g. 64QAM (quadrature amplitude modulation) with rate—5/6 error correction coding.

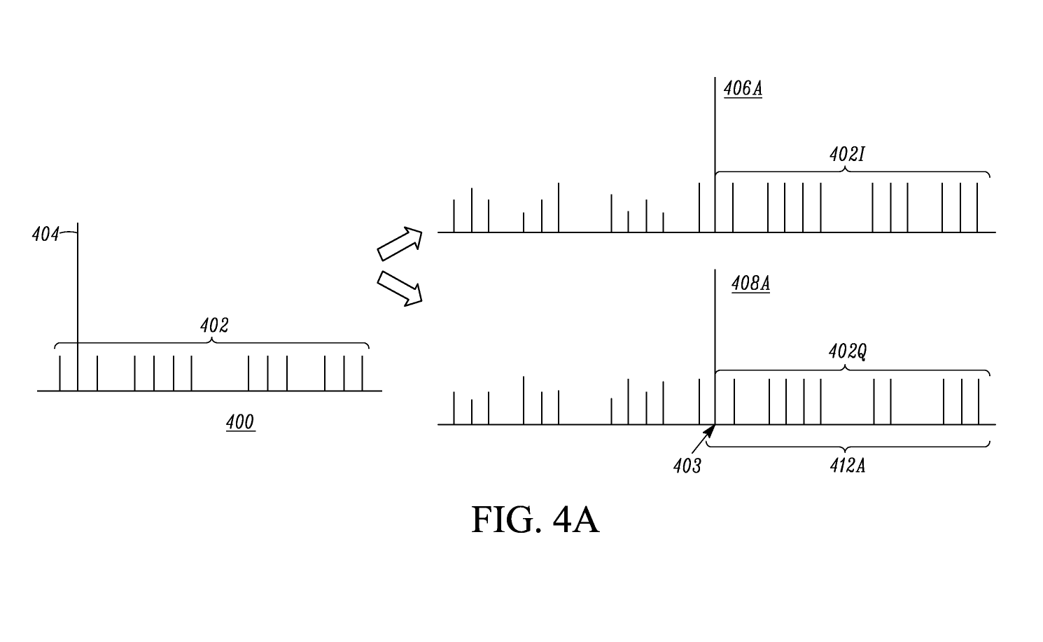

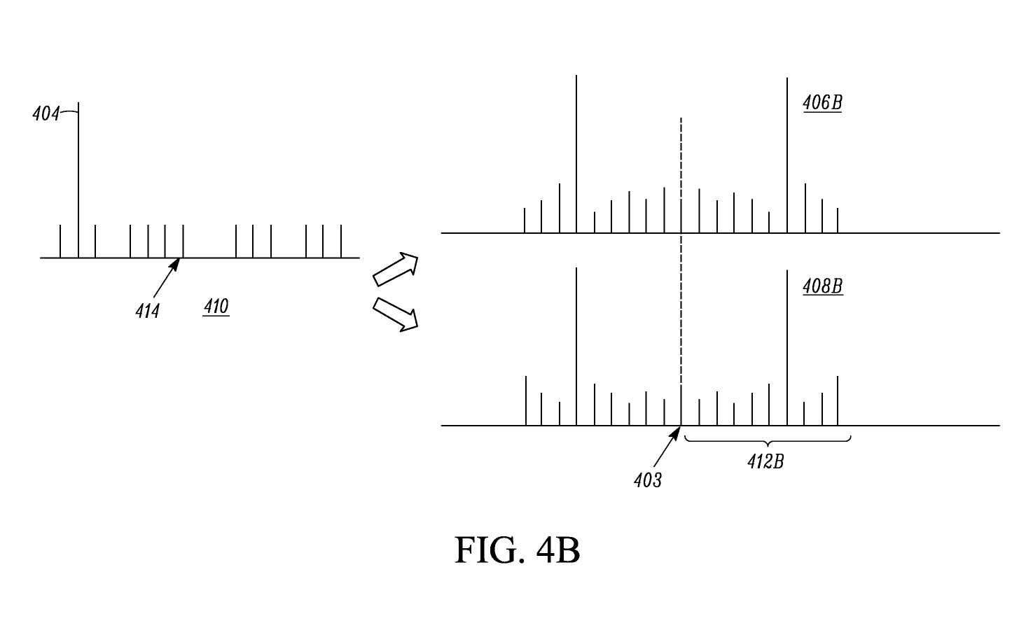

In a radio receiver that employs the multi-carrier opportunistic spectrum reuse technique as shown in 400 of FIGS. 4A and 4B, a weak multi-carrier signal 402 in the midst of a single strong interfering signal 404 should be able to find a single LO frequency to avoid image balance problems where the images from the interfering signal fall on weak desired channels. An exemplary embodiment shown in FIG. 4A would put the down conversion LO at the interferer frequency, thus converting the band to in-phase 406A and quadrature 408A components with the interferer at DC 403 where no image would be generated. As used herein, the term “interferer” is defined as undesired images that are >20 dB stronger than a signal to be communicated on a desired channel. Note that the spectrum in 406A and 408A looks different from the RF spectrum 400 because it is made symmetric about DC in the down conversion process (they are both real waveforms and hence symmetric about DC as shown by 402I and 402Q). The original information is recovered by using prior art mathematical combinations of the in-phase and quadrature information. Since subtraction is one of the operations used, exact cancellation will not result if exact scaling balance is not maintained in the two branches, leaving a residue behind that obscures the recovery of the original information. This LO selection strategy has the advantage of enabling simple rejection of the interferer by a predetermined amount with a fixed high-pass filter (by tuning the frequency of the dominant interferer to the fixed frequency channel reject filter) before passing the signal to analog to digital (A/D) converters in the receiver, reducing the dynamic range demands placed on the A/D converters. With this LO choice, the A/D converter processes baseband bandwidth 412A. If the interferer 404 is near the edges of the band, as shown in the spectrum in FIG. 4B, it may be preferable to place the LO 414 near the middle of the band and merely place the interferer on an unused channel. This strategy minimizes the amount of bandwidth to be processed since the A/D converters process nearly twice the bandwidth when placing the LO close to one of the edges of the band compared to a more centered LO. This is shown by the symmetric portion 412B of the I and Q spectra 406B, 408B in FIG. 4B vs. the symmetric portion 412A of the I and Q spectra 406A, 408A in FIG. 4A.

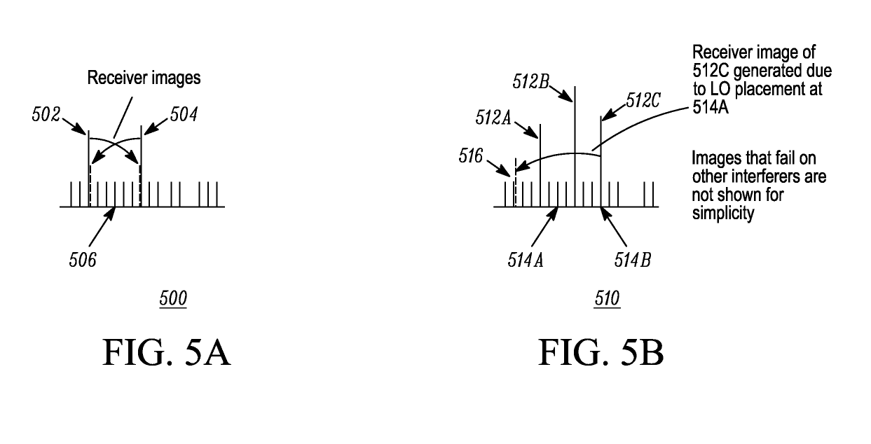

When more than one interferer is present, by using the symmetric fold point receiver technique, a plurality of down-converters in the receiver can be used with different LO frequencies such that desired channels that are obscured by otherwise unavoidable high power images with one LO can be recovered with another LO. FIG. 5A illustrates an example in which the equivalent image generations (shown as dashed lines) are shown at RF instead of showing the baseband signals to simplify the pictures. Two large interferers 502, 504 are present in the spectrum 500. When only two interferers are present, a fold point 506 can be found halfway between the interferers such that the imperfectly rejected image from one interferer falls on the other interferer, and vice-versa, and the images do not render any other channels useless.

When more than two interferers are present as shown in the spectrum 510 of FIG. 5B, at least two down-converters with two LOs are used to avoid losing potential opportunistic channels to interferer images. Specifically, with three interferers 512A, 512B, 512C as shown in FIG. 5B, one LO 514A can be set at the midpoint frequency between two of the interferers, e.g. 512A and 512B. The third interferer 512C can be managed in several ways. In one embodiment, the second LO 514B can be set on the third interferer 512C so that it converts to DC and hence generates no images. In a different embodiment, the second LO 514B can be set on the opportunistic carrier 516 that was lost due to the image of the third interferer 512C in the first conversion, so that that one opportunistic channel can be recovered. This latter approach allows a lower complexity narrowband backup converter for processing only a single narrowband channel, provided handling three large interferers was sufficient. In a third embodiment, the second LO 514B can be set at the midpoint between a different pairing of interferers, e.g. 512A and 512C, so that those two images fall on top of each other. Note that the desired channels that are free from image contamination in both down-converters in the receiver may be processed by either receiver branch but need not be processed by both as there is no advantage gained since both signals have been through the same front-end noise lineup.

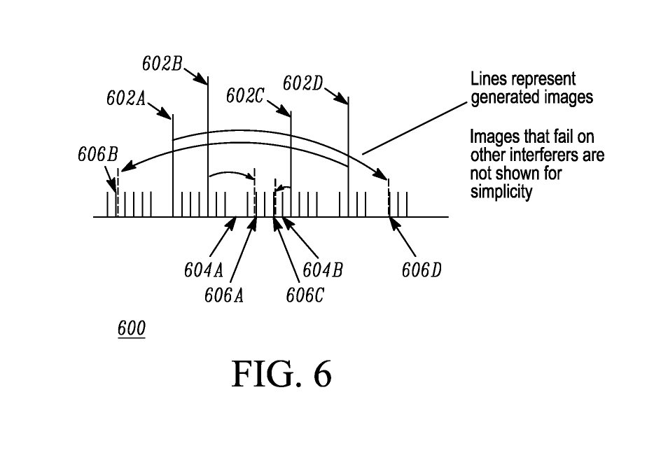

When there are more than three large interferers to contend with, in one embodiment both conversions use the midpoint-LO selection strategy so that pairs of interferers fold on top of each other as in shown FIG. 6. Which pairs of interferers are picked for folding generally may be arbitrarily or randomly selected, but the pairs of interferers that yield LOs closest to the center of the band reduce the bandwidth requirements on the baseband processing. In the spectrum 600, large interferers 602A, 602B, 602C and 602D are distributed across the band. In one embodiment, the first converter's LO1 604A is set at the midpoint of interferers 602A and 602C while the second converter's LO2 604B is set at the midpoint of interferers 602B and 602D. The two desired carriers 606A, 606B that were lost to images in the first converter can be recovered in the second converter. Meanwhile, the carriers that are lost in the second converter 606C, 606D, are recovered in the first converter.

When more than four large interferers are present, at least three conversions are used to ensure that no opportunistic channels are lost. However, the small likelihood of such a large number of large interferers may not warrant the added cost and complexity of adding yet another converter and LO and the associated processing in a radio. Instead, in the rare event that more than four large interferers are present, the LOs are selected in one embodiment to minimize the image interference to the opportunistic channels. Each combination may be tested to determine which LO choices result in the fewest number of lost opportunistic channels. For example, where there are five interferers present, there are twelve possible LO choices as midpoints of pairings of interferers. For K interferers taken this way, there are K choices for the first element of the first pair, K-1 for the 2^{nd} element of the first pair, K-2 for the 1^{st} element of the second pair, and K-3 for the 2^{nd} element of the second pair. Of these two sets of pairs, the pairs can be interchanged (a factor of two) without changing the LO choice, and the ordering of the individual pairs can be reversed (a factor of 2×2), so there are 8 different arrangements that give the same two LOs, giving a total set of the two LOs of size K!/[8(K-4)!], where ‘x!’ represents the factorial operation, or the sequential product of the integers from 1 to x, with 0!=1. As an example, for interferers at frequencies denoted A, B, C, D and E, the midpoint LO selections of the pairing (AB, CD) gives the same LO choices as the pairings (AB, DC), (BA, CD), (BA, DC), (CD, AB), (CD, BA), (DC, AB) and (DC, BA). For each of the LO pairings, the images of the interferers are easily calculated to determine which pairing gives the minimum number of opportunistic channels obscured by interferer images. For the receiver, if images fall on other licensed channels that cannot be used opportunistically anyway, there is no impact to the opportunistic use so these cases are acceptable.

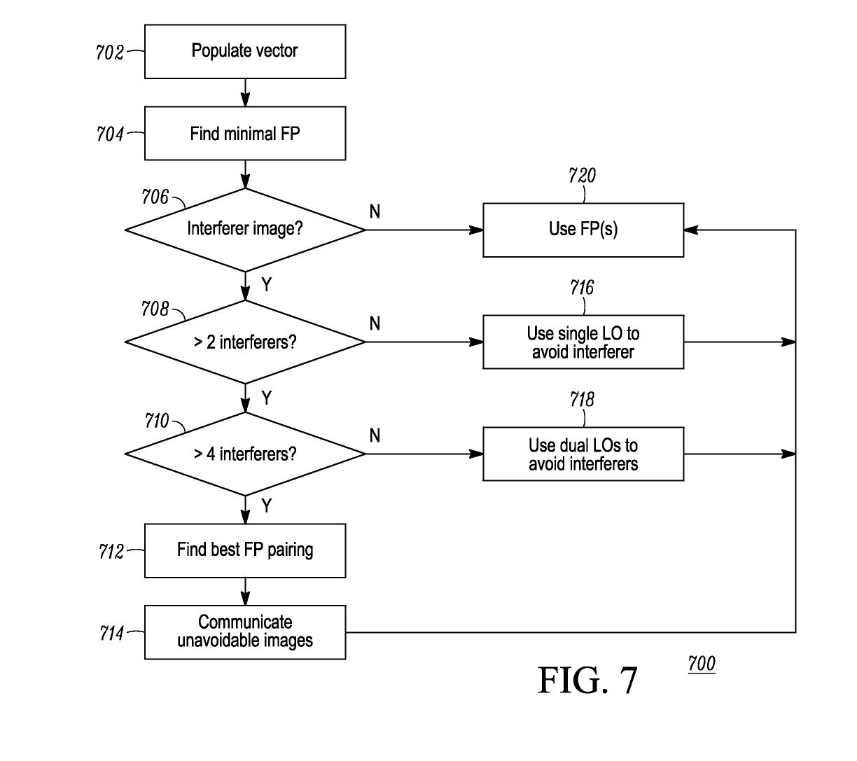

The above-described receiver LO selection method for determining sets of fold points is formalized in FIG. 7, which shows one embodiment of a flow chart for the selection of down-conversion LO frequencies for a multiple-converter receiver. Note this process need not be used exclusively for reception of signals with symmetrically disposed carriers. For reception of symmetric carriers, usage of the same fold point as was selected by the transmitter (to be discussed below) results in harmful-image-free reception of the carriers, provided the fold points were initially selected to avoid frequencies with other occupants (i.e., interferers). Hence the symmetric selection of channels in the transmitter inherently results in a receive signal that can be satisfactorily processed with finite balance down converters, as the images of the used carriers are approximately equal except for frequency selective fading effects, and the nominal image balance is sufficient to satisfactorily demodulate the signal. The method 700 shown in FIG. 7 allows for reception of asymmetrically disposed carriers as well and is thus more generally applicable to reception of signals from base stations that can afford the luxury of having higher power, higher performance IF generation of asymmetric distributions of signals to achieve greater spectrum utilization.

The method 700 assumes that the radio has multiple LOs associated with multiple down converters, one or more of which are able to be selected. Initially, in step 702, the vector of channels used by the desired multi-channel opportunistic signal is populated via control channel communication from sending node as discussed below. Then, at step 704 the receiver uses the occupied signal channels to determine a fold point that minimizes the image overlap for the combination of carriers that comprise the signal. It is then determined at step 706 whether using the fold point results in any interferers that present images in the desired channels. If no interferers are present, at step 720 the fold point is selected as the LO frequency and a single LO and a single demodulator is used to receive the signals.

If interferers are found, the number of interferers is determined as the number of LOs used depends on the number of down converters and the number of interferers present. Specifically, at step 708 it is determined whether more than two interferers are present. If no more than two interferers are present, a single down-converter is used at step 716. In particular, the local oscillator frequency of the down-converter is set at step 716 so as to place the interferer image on an unused channel if only one interferer is present. If two interferers are present, the local oscillator frequency can be set so that the images of the interferers fall on unused channels, but this will not generally be the case. More generally, the LO is set to the average frequency of the two interferers so that the images of the two interferers land on each other rather than on an occupied channel.

If more than two interferers are present, at step 710 it is determined whether there are less than four interferers present in the band. If three or four interferers are present, these interferers are still able to be accounted for by judicious use of only two down-converters. In particular, at step 718 a dual down-converter technique is used in which each down-converter is set to the average frequency of two of the interferers. If three interferers are present, one of the down-converters is set to the average frequency of the first and second interferers while the other of the down-converters is set to the average frequency of the first and third interferers or to the average frequency of the second and third interferers (i.e., to averages of overlapping pairs of interferers). Alternately, the other of the down-converters is set to a frequency at which the image of the non-paired interferer falls on an unoccupied channel, or a single-channel second down converter can be tuned to the channel that was lost due to an interferer image reflection in the other conversion. If four interferers are present, one of the down-converters is set to the average frequency of the first and second interferers while the other of the down-converters is set to the average frequency of the third and fourth interferers (i.e., to averages of non-overlapping pairs of interferers).

If more than four interferers are present, as above the use of two down-converters is not likely to be adequate to avoid all of the images of the interferers, depending on how the interferers are disposed in the band (and thus out of control of the receiver). However, even if all of the images may not be avoidable, by selecting the receiver LO frequencies properly, a tolerable level of interference may be achieved. Specifically, if at step 710 it is determined that there are more than four (e.g., K>4) interferers present in the band, at step 712 the process iterates through all pairs of K!/(8(K-4)!) average frequencies for the interferers to find which pairing of fold points offers the greatest performance. Performance may be graded on several parameters, such as signal to noise ratio, signal to interference plus noise, error rate, or throughput.

In one embodiment, the metric of performance is Quality of Service (QoS) in the system. The QoS includes channel capacity, a combination of the number of channels in the multi-channel signal and the signal to noise ratio or signal to interference plus noise ratio per carrier, along with latency and other network metrics. The pairs of average frequencies for the interferers can be iterated through to find which pairing of fold points offers the greatest QoS. For example, if capacity is the primary parameter of interest and carriers have different amounts of capacity due to environmental noise levels for frequency selective channels, the fold points may be selected so that the interferers do not interfere with the carriers having the greater capacity. In another embodiment, the LO frequencies are selected such that the interferer images fall on the minimum number of multi-carrier channels. If there are images that cannot be avoided, at step 714 the receiver communicates with the base station or repeater via established control channels which image(s) cannot be avoided and/or to temporarily abandon the use of some of the carriers.

For the opportunistic transmitter, the same strategy of folding interferers onto themselves may be used, except now the interferers are generated by the opportunistic radio and the channels to avoid contaminating are the channels used by licensees (known, e.g., via the control channel communication). To keep the transmitter simple, only a single symmetric carrier placement is described; however this should not be considered a limitation as an arbitrary number of direct-launch modulators could be used just as an arbitrary number of direct conversion demodulators could be used in the receiver to take advantage of more symmetries. For example, for asymmetric opportunities that could be decomposed into combinations of symmetric opportunities, having more than one direct conversion modulator could enable finding larger spectrum opportunities to exploit while still avoiding the generation of unintended images.

As an example of the effect of choosing a different transmitter fold point, Monte Carlo analyses were performed with licensed carriers randomly distributed over 240 channels (3 MHz divided into 12.5 kHz channels). Depending on the regulatory policy, it may be forbidden for the opportunistic radio to place carriers not only on the licensed channels in the vicinity but also on the channels adjacent to the licensed channels. The opportunistic radio is in this case forbidden from having a carrier fall on or adjacent to a licensed channel; thus the two channels adjacent to each licensed channel are also excluded from opportunistic selection. The bandwidth to search for symmetric opportunities in the spectrum may be limited by other policy considerations, such as the need to confine interference such as the transmitter third order intermodulation (IM3) terms to the immediate band of interest to keep the IM3 terms from leaking into a neighboring service's band. The bandwidth at a fold point is defined in one embodiment by the channel number and by the constraint that the IM3 terms fall within the 240 channels. Thus, fold points near the edges offer typically smaller bandwidths, while fold points that are more centered offer greater bandwidths. Other embodiments could use other definitions given other constraints.

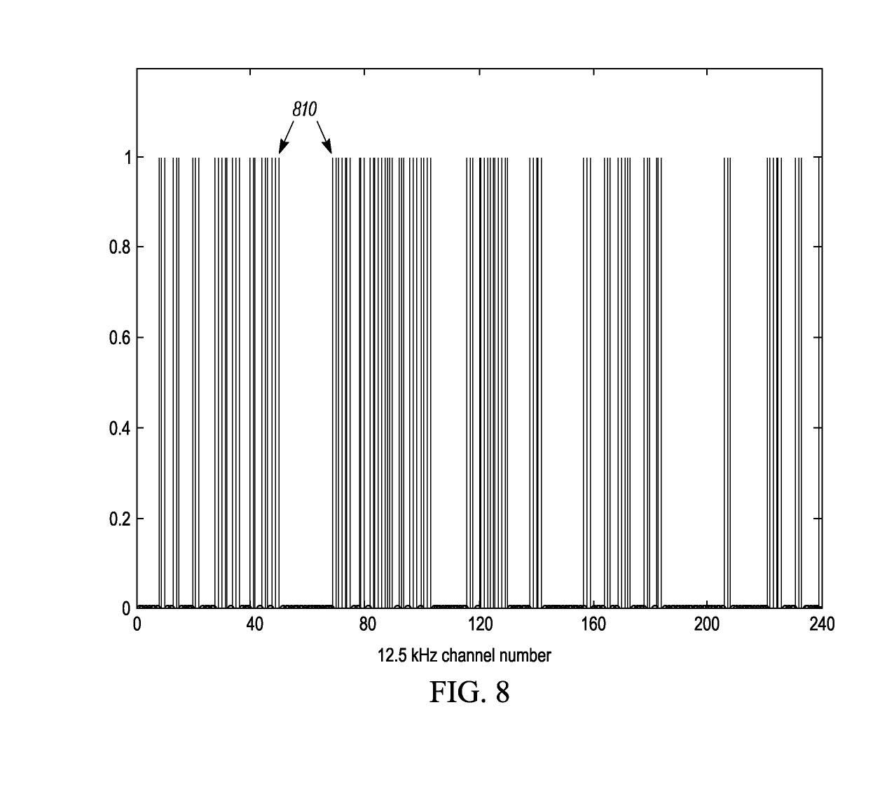

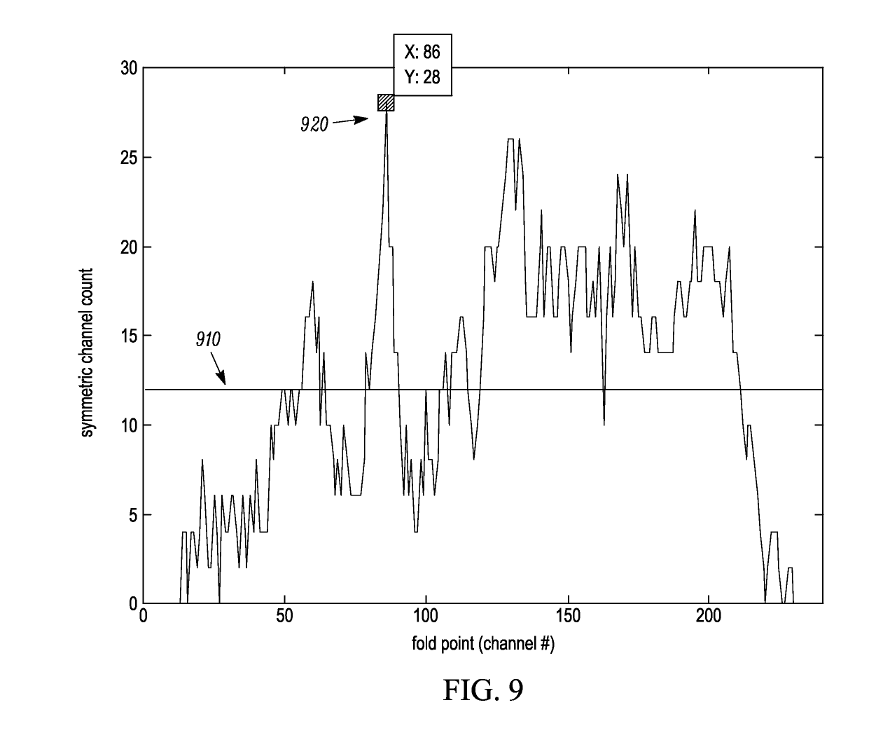

FIG. 8 shows an example carrier distribution in which 40 of 240 carriers are occupied by licensed channels (marked by vertical lines, a representative few of which are labeled 810). The adjacent channels are also conservatively marked as occupied in this plot so that they would be excluded from opportunistic consideration to enhance protection to the licensees. For this distribution, the number of symmetrically placed channels versus fold point is shown in FIG. 9. FIG. 9 also shows the horizontal 12-channel line 910; points above this line have at least 12 channels of symmetric spectrum available for the given fold point. Using 12.5 kHz channels, twelve channels correspond to 150 kHz of aggregated bandwidth. This is considered in one embodiment as a minimum amount of bandwidth for wideband applications. For this example there are 128 fold points that allow ≧12 symmetric channels, whereas only 9 fold points have ≧24 symmetric channels (300 kHz aggregate bandwidth). The maximum is 28 symmetric channels (350 kHz aggregate bandwidth) for a fold point 920 marked at channel 86 (i.e., ‘X’=fold point channel number=86, ‘Y’=number of symmetric channels available=28.

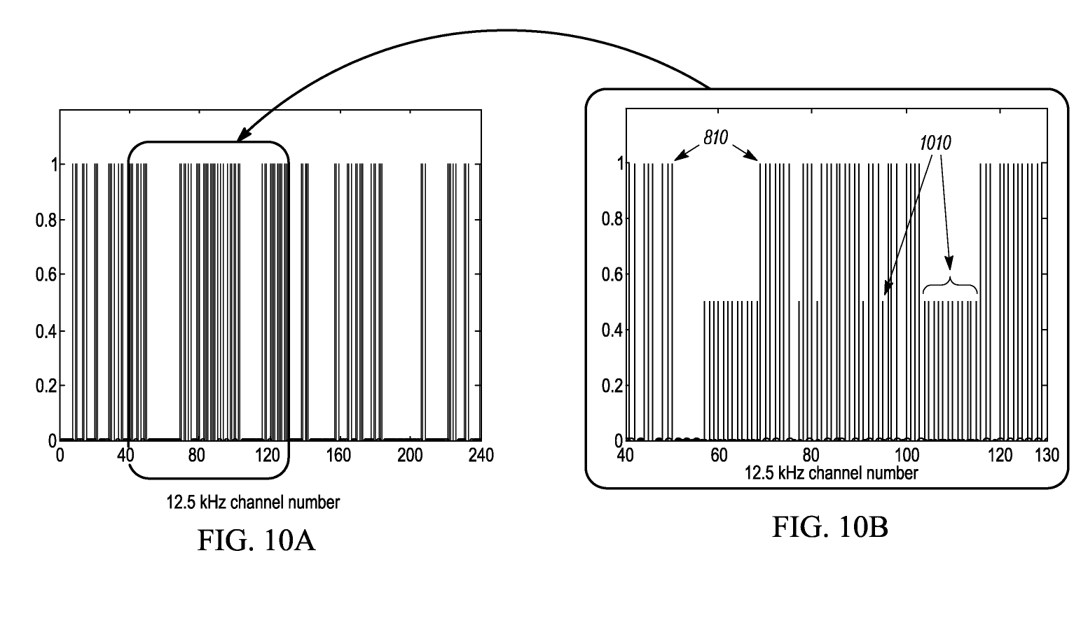

FIG. 10A illustrates the spectrum of FIG. 8 with channels 40-130 outlined. FIG. 10B shows a magnified view of FIG. 10A in which the distribution for the case of the maximum number of symmetric channels is plotted. As shown in FIG. 10B, the licensed channels and corresponding adjacent channels from FIG. 10A are centered on the fold point of channel 86. There are 28 opportunistic carriers; 12 in each larger grouping and four isolated carriers closer to the fold point than the larger groupings. The licensed channels and corresponding adjacent channels are the taller lines 810; the symmetrically disposed opportunistic channels are the shorter lines 1010. Using this approach, the opportunistic transmitter does not generate IQ imbalance images that would fall on the licensed channels or corresponding adjacent channels. Similarly, the opportunistic receiver that chooses this same fold point is not interference-limited by its IQ imbalance but is rather ensured of receiving the symmetric opportunistic carrier set while avoiding folding interferers onto the set, since an interferer does not fold onto a symmetric opportunistic carrier unless the interferer was itself on an opportunistic channel.

Although the simulation example shown in FIGS. 8-10 shows a maximum symmetric channel availability of 28 channels, the maximum depends entirely on the particular distribution of occupied licensed channels, which varies in different geographical regions and in a particular geographical region over time. The maximum symmetric channel availability was observed using a Monte Carlo simulation of 1000 trials with 40 of 240 channels occupied by licensed transmitters. The Monte Carlo simulation showed a median number of maximum symmetric channel availability of 36 channels (450 kHz), with a minimum of 20 channels (250 kHz) and a maximum of 58 channels (725 kHz) of aggregate bandwidth.

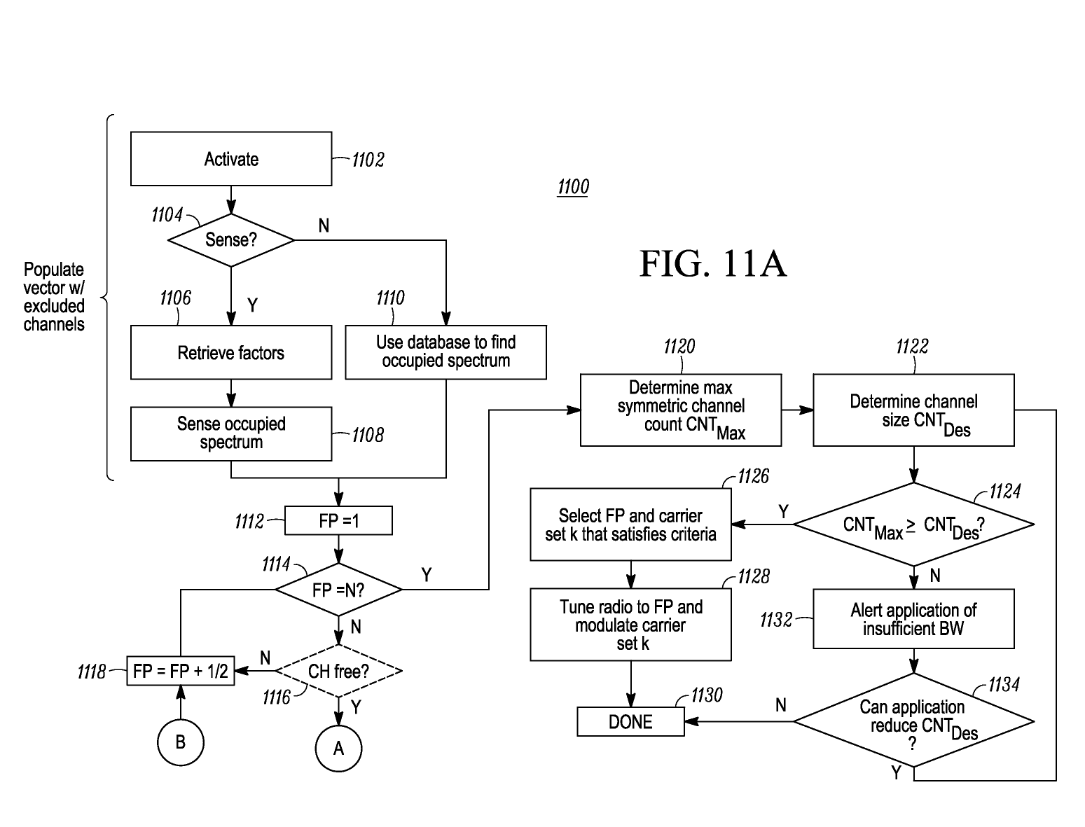

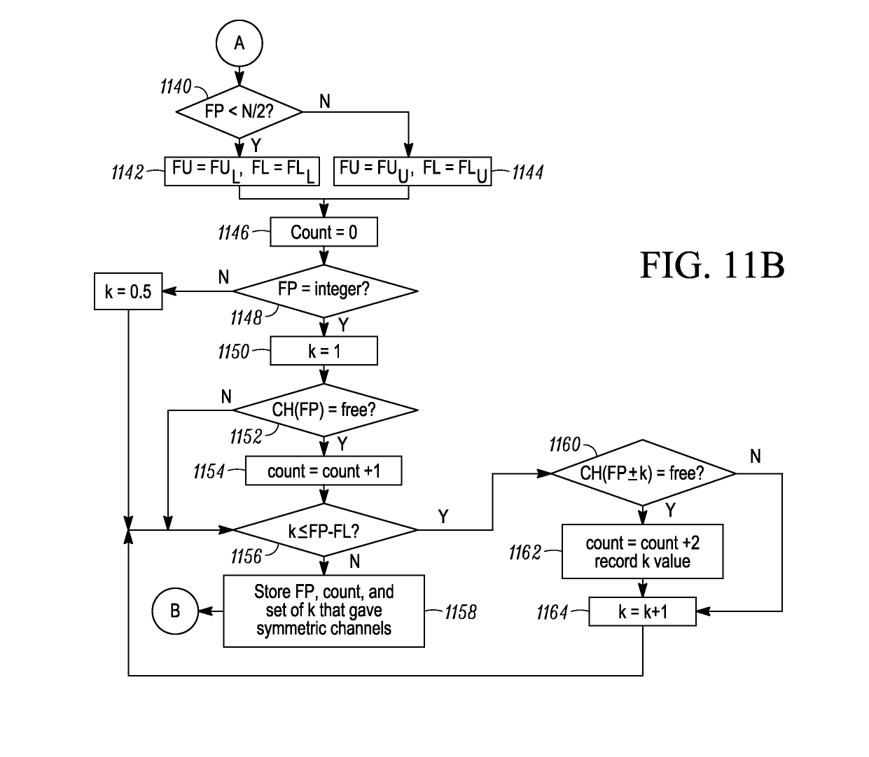

An example of a method of determining at least a minimally desirable fold point (denoted ‘FP’) and available channels for transmission is shown in the flowchart 1100 of FIGS. 11A and 11B. When the radio activates at step 1102 and before it is to transmit data at a wideband rate (i.e., a rate significantly higher than the available single narrowband channel allows) it determines on which channels such a transmission should occur. This information may be provided from the base station or other master node via a control channel, for example.

At step 1104, it is determined whether the radio is to use a database to determine the occupied spectrum or whether the radio is to determine the occupied spectrum by sensing the channels being used in the spectrum. In the former case, at step 1110 the radio determines its location (by e.g. GPS or other location technology) and accesses either an external database such as the above-mentioned FCC database through its control channel (which could be a predetermined licensed or unlicensed channel), or it may have an internal database in memory. The internal database may be periodically refreshed from time to time to update the licensed users and thus occupied spectrum in the geographical area of operation of the radio. Updating can occur at some regular time, e.g., each shift change (i.e., if the radio changes users from one shift to another), or after a predetermined time period, e.g., monthly, due to the relative infrequency of federal license grants, provided the radio remains in the same geographical area of operation. The database also may be updated if the radio moves to a different geographical area (e.g., served by a different base station).

If the radio is to determine the occupied spectrum by sensing spectrum usage, at step 1106, factors that determine the sensitivity of the sensing operation, including a detection threshold, an integration or averaging time of the signal, and an observation time for licensed radios that are known not to be in continuous operation, are retrieved from internal memory and used at step 1108 to sense usage in the spectrum by receiving signals broadcast by potential interferers in the case of an opportunistic receiver or potential victims in the case of an opportunistic transmitter. As shown, in this portion of the method 1100, the vector of excluded (occupied) channels is populated and used in later determinations. The use of sensing alone may not be desirable as it cannot in general discern whether a spectrum occupant is licensed or unlicensed, unless some usage pattern or signal characteristic would so indicate.

Regardless of the manner in which the radio determines the excluded channels, the excluded channels are stored in internal memory for exclusion when determining available channels. This determination starts at step 1112 by initializing the fold point FP, which is the first channel in the spectrum. Specifically, an integer fold point number indicates the center frequency of a channel in the band. At step 1114 it is determined whether the fold point number has reached its terminal value, which as shown is the total number N of channels in the spectrum. In other embodiments, the fold point initial and terminal value may be less than the total number of channels in the spectrum as the process may start and/or terminate at a predetermined number of channels from the end of the band forming the spectrum.

The initial and terminal values are each generally determined from the database and may take into account the policy of starting/terminating from the end of the band. When it is determined at step 1114 that the last potential fold point has not been reached (i.e., the terminal value), the radio proceeds to optional step 1116 (denoted as a dashed line in FIG. 11A) which determines if the fold point channel itself is available, or if the fold point is between channels, if they are both available. This step is included for example in systems with modulators that have LO leakage that also fails to satisfy the emissions mask. If the fold point is on or between occupied channels and the leakage exceeds a mask level, then the mask is violated. If however the fold point channel or surrounding channels are vacant, that/those channel(s) could be modulated. If this test is desired (depending on the modulator performance) and the channel is determined to be occupied (i.e., it would not be used as a fold point because the LO leakage would violate the mask), that fold point is abandoned and the fold point is incremented at 1118. The process then continues on as shown in FIG. 11B.

At step 1140 it is determined which half of the band the fold point occupies, i.e., whether the fold point number has reached a number that is greater than or less than half the total number of channels in the spectrum (N/2). Note the fold point may be defined as either the center frequency of a particular channel (called a channel-centered frequency) or a frequency in-between channels (called a channel-edge frequency)—either point being able to support symmetric opportunities throughout the spectrum. For example, a fold point of 10.5 between channels 10 and 11 would allow use of channels 10 and 11 as channels symmetric about the fold point between them, while a fold point centered on channel 15 would allow symmetric use of channels 14 and 16, and even channel 15 itself (since it too is symmetric about a fold point centered on itself) provided it is vacant. After band-half determination, upper and lower limits FU and FL, respectively, for symmetric opportunistic consideration are set. FU and FL are dependent on which half of the band the fold point FP occupies. In one embodiment that contains IM3 spurs to the frequency band of interest (i.e., the set of channels 1:N) for fold points less than or equal to N/2, at step 1142 the lower channel limit (FL) is set to the ceiling (or rounding up to the next larger integer) of FP−Δ, where Δ is defined as one half the floor (or rounding down to the next lower integer) of ⅔ of (FP−1), while the upper channel limit (FU) is set to the floor of FP+Δ. In equation form,

Δ=½└⅔(FP−1)┘

FL=┌FP−Δ┐

FU=└FP+Δ┘.

For example, if there are 100 channels (N=100) and FP=channel 3.5, FL=ceiling [3.5−0.5]=3 and FU=floor [3.5+0.5]=4, so channels (3,4) could be used with FP=3.5 while keeping the lower IM3 term at 2×3−4=2, which is within 1 to N. Had the set of channels been (2, 3, 4, 5) around FP 3.5, then the lower IM3 term would have been 2×2−5=−1, outside the range of 1 to N. If FP=8, Δ=2, FL=6, FU=10, and the lower IM term of (6, 7, 8, 9, 10) is 2×6−10=2, within 1 to N. For fold points greater than N/2, FL and FU are still defined the same way but 4 is different, being ½ of the floor of ⅔ of (N−FP). In equation form,

Δ=½└⅔(N−FP)┘

FL=┌FP−Δ┐

FU=└FP+A┘.

If it is determined at step 1040 that the fold point is a frequency higher than the middle of the band, at step 1144 the upper and lower limits are set according to the above equation. For example, if FP=70, Δ=10, FL=ceiling (70−10)=60 and FU=floor (70+10)=80. The maximum IM3 channel is then 2×80−60=100. If FP=95.5, Δ=1.5, FL=ceiling (95.5−1.5)=94 and FU=floor (95.5+1.5)=97. The maximum IM3 term is then 2×97−94=100. Note that these are merely examples of how the upper and lower floors are set. Again, these examples serve to contain third order intermodulation spurs to the channels 1 through N. Other algorithms may be used in different embodiments, dependent on for example, whether policy allows such spurs to be permitted outside the band.

Regardless of how FU and FL are set, the number of symmetric opportunities (referred to as the count) may now be counted for the current fold point. At step 1146, the count is initialized to 0 for the fold point number FP. At step 1148, it is determined whether the fold point whose symmetric opportunities are currently being investigated is on a channel or between channels—i.e., whether the fold point number is an integer or a half integer (per the half-integer steps of step 1122). If the radio determines at step 1148 that the fold point number is not an integer (and thus the fold point is between channels), a temporary index k is initialized to 0.5 at step 1166 and the radio continues to step 1156. The temporary index is used to step, channel by channel, from the fold point to the channel of the upper/lower limit FU or FL. The index k records the symmetric channels available for communication.

If the radio determines at step 1148 that the fold point number is an integer (and thus the fold point is centered on a channel), at step 1150 the temporary index k is initialized to 1. The radio then determines at step 1152 whether the channel associated with the fold point is free or excluded. The optional step 1116 above may be applied here instead. If it is determined at step 1152 that the channel is excluded, the radio continues to step 1156. If it is determined at step 1152 that the channel is free, the count is incremented (since the fold point channel itself could be used) at step 1154 before continuing to step 1156.

At step 1156, it is determined whether the temporary index is less than or equal to the difference between the fold point number and the lower channel limit FL (or equally between the upper channel limit FU and the fold point number FP). This difference is the number of channels between the fold point and one of the limits and thus the max number of iterations of the loop started at step 1156. During each iteration (exemplified by steps 1160-1164), it is determined at step 1160 whether both channels associated with the difference between the fold point number and the temporary index (CH(FP−k) and CH(FP+k)) are free. If it is determined at step 1160 that the symmetric channels are free, at step 1162 the count is incremented by 2 (1 for each symmetric channel) and the temporary index k is recorded for that fold point and then incremented by 1 at step 1164 before returning to step 1156 to determine if the channel space has been exhausted. If it is determined, however, at step 1160 that at least one of the symmetric channels is excluded (i.e., unavailable), the temporary index k is not recorded and is incremented at step 1164 without incrementing the count since no symmetric pair was found for that k value. Thus, if only one of the symmetric channels is free, no opportunities are counted for that offset index k.

When at step 1156 it is determined that the iterations are completed, at step 1158 the fold point and count as well as the k values that yielded symmetric opportunities (the channels to be used in the transmitter should that fold point be selected) are stored in internal memory of the radio before the radio returns to step 1118, incrementing the fold point by 0.5.

Returning to FIG. 11A, at step 1114 when it is determined that the last fold point has been reached and thus that no more symmetric opportunities are to be determined, the radio is ready to determine which fold point to assign for the transmission so that the wideband data is transmitted on the discontiguous channels. The recorded channel count size vs. FP is examined and the maximum count ‘CNT_{Max}’ is determined at step 1120. The communications application and number of users dictate the bandwidth (or desired count ‘CNT_{Des}’) for acceptable performance at step 1122. The desired channel count is then compared against the maximum channel count at step 1124.

If the maximum channel count exceeds the desired channel count, the fold point and associated channel set k are selected from the set of fold points that meet or exceed the desired channel count based on predetermined criteria at step 1126. The criteria may be, for example, the fold point that satisfies the desired channel count with the least number of channels, or the most localized spectrum (i.e., narrowest total bandwidth), or that produces the lowest peak intermodulation term that falls on a licensed channel. The transmitter is subsequently tuned to the fold point (as the carrier frequency) and the available channel set k populated with modulated carriers at step 1128. The process is then terminated at step 1130.

If the maximum channel count CNT_{Max} does not exceed the desired channel count, then the application is alerted at step 1132. If the application can be throttled back to fit the opportunity (e.g., reduce the desired amount of bandwidth) or substituted by a more rudimentary application at step 1134, a new lower desired channel count CNT_{Des} is submitted at step 1122 and the algorithm then continues again to step 1124 where the process continues as defined above. If the application is unable to be throttled back or substituted, the application cannot operate and the process is terminated at step 1130.

As detailed above, the algorithm records the available channels per fold point as part of the opportunity analysis process. These records are stored in tabular form in the radio's internal memory and consulted in the fold point selection. Once initially populated, the table may be updated periodically if the radio stays in the same geographical area or may be updated if the radio is used in a different band or taken to a different geographical area (i.e., in which the licensed users are different). As the symmetric opportunities for each fold point change as the fold point changes, the dynamics of the band may change substantially if a particular fold point (and its symmetric opportunities) is used. The table may be adjusted in cases in which the usage by devices other than primary licensed users is known. For example, if the radio is receiving a wideband group communication and a wideband priority message to be transmitted is initiated, the table can be temporarily updated to reflect the usage by the group communication (although the radio is no longer receiving the group communication as it is to transmit its priority message instead), thereby perhaps altering the channels on which the radio would have transmitted without being aware of the group communication.

In addition, as mentioned in relation to the Monte Carlo simulation result of FIG. 8, under certain circumstances it may be prohibited by regulatory policy for a channel adjacent to an occupied channel to also be occupied. Such a policy may, for example, seek to limit adjacent channel noise. In this case, the portions of the process in which the symmetric opportunities are counted (e.g., steps 1154 and 1160 or thereabouts of FIG. 11B) are modified so that additional steps are taken to determine whether, even if the channel is free, at least one adjacent channel is occupied. If at least one adjacent channel is occupied, the channel(s) are not counted. The adjacent channels may be established when the vector of excluded channels is populated so that the excluded channels include both the occupied channels as well as the channels adjacent to the occupied channels. This understandably substantially reduces the count and may result in the desired amount of bandwidth being unattainable.

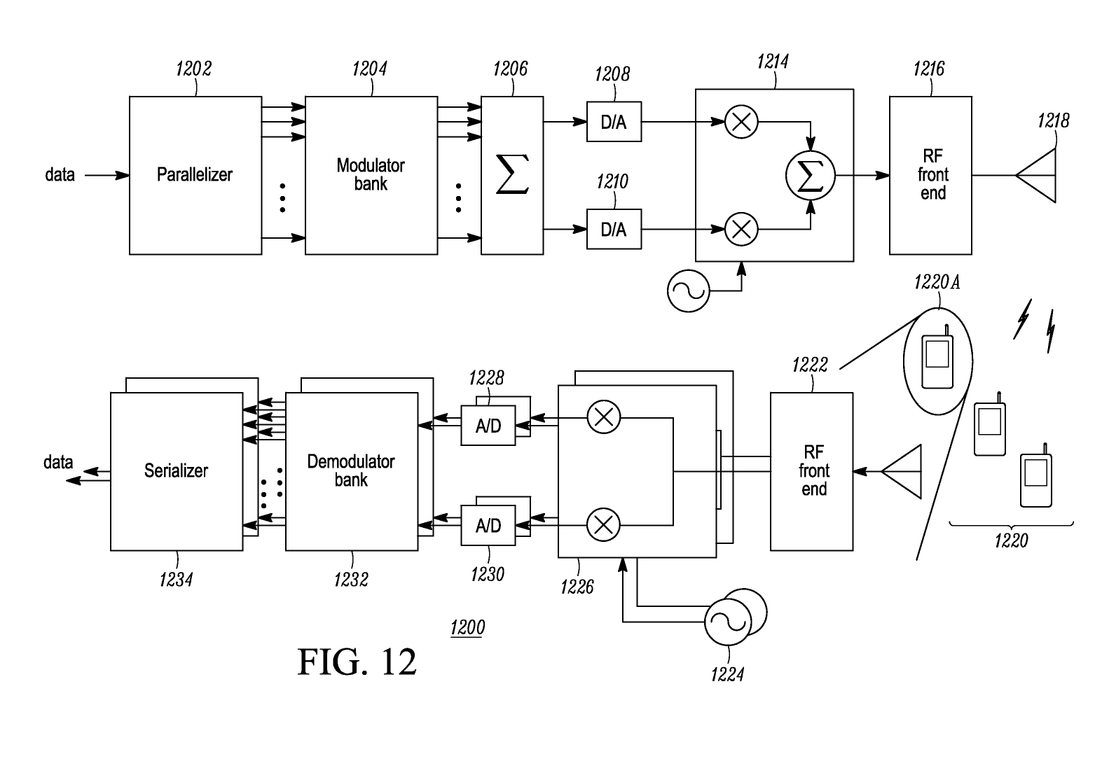

One embodiment of a radio is depicted in FIG. 12. In the transmitter 1200, once the fold point is set, digital data of the disparate channels is parallelized by parallelizer 1202 (such as a multiplexer or shift register) and modulated with the digital waveform for the carrier of that channel by one or more LOs in modulator k band 1204. The modulated data from modulator k band 1204 is then combined into a single complex digital data signal by summer 1206 and reduced to real (or in-phase ‘I’) and imaginary (or quadrature ‘Q’) components. Those skilled in the art recognize that there are especially efficient and elegant means of constructing multi-carrier signals using techniques associated with filtered multi-tone modulation. The complex digital data is then converted into in-phase and quadrature analog signals in digital to analog converters 1208, 1210, and modulated onto an RF signal using a direct launch IQ modulator 1214 and the frequency of the determined fold point applied by the local oscillator 1212, thereby synthesizing the wideband RF signal which is subsequently amplified by a power amplifier in a RF front end 1216. The analog RF signal is then transmitted via antenna 1218. It should be appreciated by those skilled in the art that other transmitter operations such as power control, leveling, and distortion linearization such as Cartesian feedback or digital predistortion may be present in the transmitter but are not further described herein.

The selected fold point, channel set, and other transmission parameters are shared amongst the group of devices 1220 via a control channel that may either be predetermined or defined by a master node that begins transmitting control information on an available channel it has selected while other elements of the network scan the set of channels to identify their master node and join the network. Such discovery techniques are known in the art. A particular communication may be of a broadcast nature to all of the devices in the group 1220, or may be to a subset of devices (multicast) or a particular device (unicast). For the sake of simplicity, a unicast transmission is assumed.

Once the modulated transmission is received by intended device 1220A, the signal is amplified and filtered in RF front end 1222 and downconverted through an IQ demodulator 1226 fed by fold point local oscillator 1224 to yield in-phase and quadrature analog baseband signals. Only a single branch of the potentially multi-branch (with two branches shown here) converter is labeled for simplicity. Those skilled in the art recognize that other operations used in the reception of the signal such as frequency offset acquisition, automatic gain control and channel estimation may also be present and are implicitly assumed here but are not further discussed as these are well known.

The analog baseband signals are digitized by analog to digital converters 1228 and 1230. After digitizing, the individual channels are separated out using methods known in the art such as digital down converters, cascaded integrator-comb (CIC) filters, decimators, and FIR filters. Those skilled in the art further recognize that there are efficient and elegant receiver implementations from the discipline of filtered multi-tone demodulation. Once separated and filtered, the individual channels are demodulated and decoded using demodulator bank 1232 and then serialized using serializer 1234. Other receiver operations known in the art such as antenna diversity or combining, de-interleaving, forward error correction, H/ARQ and other familiar techniques may also be present but are not shown or described here.

The description above details the examination and selection of spectrum opportunities in highly fractured spectrum. Database information for a given area can reveal the availability based on licensed users, but once other secondary or unlicensed users enter the area, if their activities are not recorded in the database, channels indicated as available by the database may be found to be occupied by sensing. As indicated above, sensing does not by itself distinguish between licensed and unlicensed users unless there are particular signatures in the licensed or secondary signals that uniquely identify these signals. Since other users identified by sensing diminish the spectrum opportunity, coexistence methods may be employed. Examples presented here include using the minimum channel set required by the application or selecting the fold point that offers the most localized set of channels to leave other channel groupings free for other networks to exploit. Other sharing or coexistence techniques known in the art such as listen before talk/collision-sense multiple access/collision avoidance, or coordination communications between networks in a standardized format, may be necessary or beneficial but are not further addressed here as they are outside the scope herein.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed. Also, the sequence of steps in a flow diagram or elements in the claims, even when preceded by a letter does not imply or require that sequence.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, various embodiments can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for aggregating channels in a band to transmit a multi-channel signal, the method comprising a wireless communication device:
determining a fold point and a set of available symmetric channels disposed about the fold point;
synthesizing data to be transmitted using the available channels into the multi-channel signal; and
transmitting the multi-channel signal using the fold point as a carrier frequency of the multi-channel signal.

2. The method of claim 1, wherein determining the center frequency fold point comprises iterating through a plurality of fold points in the spectrum, determining a set of available symmetric channels for each fold point, and selecting a particular fold point dependent on a QoS of the set of available symmetric channels associated with each fold point.

3. The method of claim 2, further comprising limiting iterations through the fold points by providing upper and lower bounds to limit a number of symmetric opportunities searched for in each iteration, the upper and lower bounds dependent on a current fold point being iterated through such that the number of symmetric opportunities searched for decreases as the current fold point approaches an edge of the band.

4. The method of claim 2, wherein iterating through the plurality of fold points comprises selecting channel-centered frequencies and channel-edge frequencies.

5. The method of claim 2, wherein determining the set of available symmetric channels for each fold point comprises avoiding occupied channels and channels adjacent to the occupied channels.

6. The method of claim 2, further comprising limiting iterations through the fold points based on locations of third order intermodulation products of the multi-channel signal in the band.

7. The method of claim 1, wherein the fold point is selected to provide a maximum number of available symmetric channels.

8. The method of claim 7, further comprising if the maximum number of available symmetric channels is inadequate to provide a desired amount of bandwidth, throttling back an application using the set of available symmetric channels to reduce the desired amount of bandwidth to that provided by the available symmetric channels.

9. The method of claim 1, wherein the fold point is selected to provide a minimum number of available symmetric channels sufficient to accommodate a desired amount of bandwidth.

10. The method of claim 1, further comprising to determine available channels in the band before determining the center frequency fold point and set of available symmetric channels querying an external database of users of the band or sensing spectrum usage in the band.

11. A method for using discontiguous channels in a band to receive a multi-channel signal, the method comprising a wireless communication device:
receiving information regarding which of the discontiguous channels in the band are being used to provide data of the multi-channel signal and which channels in the band are occupied by interferers;
determining a fold point in the band after receiving the information; and
receiving the multi-channel signal from another wireless communication device using the fold point as a carrier frequency of the multi-channel signal.

12. The method of claim 11, wherein determining the fold point comprises selecting a fold point that minimizes a baseband bandwidth occupied by the multi-channel components when no interferers are present that exceed an image rejection of a down converter in the wireless communication device.

13. The method of claim 11, wherein:
only a single interferer is present that exceeds an image rejection of a down converter in the wireless communication device, and
determining the fold point comprises selecting a single fold point for which an image of the single interferer falls on a channel unused by the multi-channel signal.

14. The method of claim 11, wherein:
a pair of interferers are present that exceed an image rejection of a down converter in the wireless communication device, and
determining the fold point comprises selecting a first fold point that places images of the pair of interferers either on channels unused by the multi-channel signal if possible or on top of each other using a second fold point that is an average of frequencies of the pair of interferers.

15. The method of claim 11, wherein:
more than two interferers are present that exceed image rejections of down converters in the wireless communication device, and
determining the fold point comprises selecting fold points for the down converters that recover components of the multi-channel signal interfered with in a down conversion of one of the down converters by using a down conversion of another of the down converters.

16. The method of claim 15, wherein the fold points are each an average of frequencies of a different pair of the interferers.

17. The method of claim 15, wherein determining the fold points further comprises iterating through at least a portion of all pairs of average frequencies for the interferers to find which set of fold points offers a greatest image avoidance or a maximum performance metric.

18. The method of claim 15, further comprising if there are images of the interferers that cannot be avoided by the fold points, communicating with a base station to temporarily abandon the use of at least one of the multi-channel channels that is interfered with.

19. The method of claim 15, wherein the one of the fold points is an average of frequencies of a pair of the interferers and another of the fold points is a frequency selected such that an image of one of the interferers not in the pair of interferers falls on an unoccupied channel in the band.

20. The method of claim 11, wherein the fold point is determined such that an image of each interferer in the band falls on at least one of an unoccupied channel in the band or a channel in the band occupied by another interferer.
